(19) United States
(12) Patent Application Publication
(10) Pub. No.: US 2020/0132627 A1
(43) Pub. Date: Apr. 30, 2020

(54) ION MOBILITY DEVICES AND METHODS

(71) Applicant: ION DX, INC., Monterey, CA (US)

(72) Inventors: W. Henry Benner, Danville, CA (US); Michael J. Bogan, Pacific Grove, CA (US)

(73) Assignee: ION DX, INC., Monterey, CA (US)

(21) Appl. No.: 16/622,149

(22) PCT Filed: Jun. 14, 2018
(86) PCT No.: PCT/US2018/037623

§ 371 Date: Dec. 12, 2019

Related U.S. Application Data
(60) Provisional application No. 62/519,842, filed on Jun. 14, 2017.

(51) Int. Cl. G01N 27/62; H01J 49/28

(52) U.S. Cl. CPC G01N 27/622; H01J 49/28

(57) ABSTRACT

Methods of ion mobility spectrometry are provided in which a sample material is modified by exposing the sample material to physical stress to produce a modified material, ions are generated from the modified material to produce generated ions, the generated ions are separated to produce separated ions and the separated ions are detected. The modified material is delivered to an electrospray generator and are separated and detected. Embodiments of the invention modify the ions after they are generated. After detection, the data is processed mathematically to produce processed data that is recognized by experts in the field of ion mobility spectrometry. Apparatuses are provided to carry out the methods.

### CROSS-REFERENCE TO RELATED APPLICATIONS

This application claims the benefit of U.S. Provisional Patent Application No. 62/519,842 titled “Ion Mobility Devices and Methods,” filed Jun. 14, 2017, incorporated herein by reference.

### BACKGROUND OF THE INVENTION

### Field of the Invention

The present invention relates to analysis of gas-phase ions, and more specifically, it relates to ion mobility spectrometry.

### Description of Related Art

Electrical mobility is a fundamental property of ions. Electrical mobility measurements are performed by measuring the velocity of an ion as it travels through a gas under the influence of an electric field. The electrical mobility constant for an ion, K, is the ratio of ion velocity (v) to electric field strength (E) as K=v/E. K represents electrical mobility for local gas and electrical conditions or, when its value is reduced to standard conditions, is expressed as Ko. Smaller ions fly faster in a given electrical field than equally-charged larger ones because larger ones experience greater aerodynamic drag. Determining K or Ko is useful for a number of applications. In the field of aerosol science, electrical mobility measurements are used to determine the size of nanoparticles and water droplets. Electrical mobility measurements also serve as the basis of lipoprotein analysis whereby the size HDL and LDL cholesterol particles are used to predict coronary heart disease. Electrical mobility of gas phase ions, known simply as ion mobility, has been growing in popularity as a method to characterize the shape of proteins across a large size or molecular weight range. A number of techniques have been described for performing such measurements and they are typically based on the use of an ion mobility mass spectrometry. Less well known is the use of a differential mobility analyzer for measuring the size of proteins.

### Overview of Prior Art for Ion Mobility Measurements

### Exemplary Prior Art for Ion Generation:

The electrospray process converts substances in solution to gas-borne ions. The substances in solution can be understood to be the sample. An example of a sample is a protein dissolved in an aqueous buffer. An example of a way to generate electrospray ions for ion mobility analysis is to use a model 3482 electrospray generator commercially available from TSI., Inc. This device applies high voltage to liquid flowing through a capillary causing the liquid to erupt into a spray of highly-charged microscopic droplets that leads to gas-phase ions after the droplets evaporate. Ion mobility measurements have been made with singly- or multiply-charged ions.

### Overview of Prior Art for Sample Processing:

Sample processing can be understood to be the addition of or the removal of a substance from the sample or the application of physical process such as heat or cooling to the sample. Samples are typically desalted and buffer-exchanges before subjected to ion mobility analysis. These processes are commonly performed with disposable dialysis chambers or with liquid chromatographs. Typically, these steps are performed before a sample is electrosprayed and not during the time the sample is electrosprayed. In-line sample processing during the time a sample is electrosprayed is not commonly available technology.

### Prior Art for Ion Mobility Measurements:

Two commonly used techniques for producing ion mobility measurements begin by introducing ions into a space between two metal electrodes. The space between electrodes may be the annular space between two concentrically aligned cylinders or the space between two parallel electrode plates. Cylindrical chambers, such as the nano-differential mobility analyzer (nDMA, manufactured by TSI, Inc.) is one example of an ion mobility separating device. The parallel plate arrangement, such as the “Half-Mini” differential mobility analyzer (DMA) manufactured by SEADM is a second example of an ion separating device. A condensation particle counter, such as the model 3775 manufactured by TSI, Inc is an example of an ion detector that can be used in combination with a nDMA or a parallel plate DMA.

The operating principles of the nDMA are well known by experts in the field. It is a device based on the concentric alignment of two metal cylinders—a smaller one located inside a larger one. A flow of gas called a sheath flow is introduced into the annular space between the two cylinders. Ions are injected into a portion of the sheath flow along the inside of the outer cylinder. The injected ions, as they are carried by the flow of sheath gas, are subjected to an electric field produced by a first voltage applied to the outer cylinder and a second voltage applied to the inner cylinder. The electric field forces the injected ions to traverse the annular space. An ion detector connected to the inner cylinder provides a way to detect ions of a specific mobility. Knowledge of the width of the annular spacing between the inner and outer cylinders, the sheath gas flow rate, the voltages applied to each cylinder and the length of the annular space provide experts in the field a way to calculate ion mobility using an appropriate mathematical.

The operating principles of a parallel plate ion mobility analyzer are similar to the operating principles of the nDMA but instead of providing an electric field across the annular space between two concentric metal cylinders, an electric field between two parallel metal plates is used.

A third type of apparatus for measuring ion mobility is a time-of-flight (ToF) ion mobility spectrometer. The most common examples of ToF ion mobility spectrometers are ion mobility spectrometers that are operated in tandem with a mass spectrometer. These apparatuses are called ion mobility mass spectrometers and are operated in a two-step process—ions are first subjected to mobility analysis, typically by means of a drift tube, and subsequently subjected to mass analysis by use of a mass spectrometer.

The nDMA and parallel plate DMA's are typically operated at atmospheric pressure. This pressure regime allows ions to be detected using a condensation particle counter (CPC). ToF ion mobility spectrometers typically are operated at sub-atmospheric pressure, typically less than 0.5 Atm., which precludes the use of a CPC.

### Prior Art for Gas-Phase Ion Processing:

The processing of gaseous ions can be understood to be an alteration that is made to modify physically or compositionally ions in the gas-phase. The most common form of ion processing in ion mobility spectrometry is to reduce the charge carried by electrospray ions by exposing them to a bipolar cloud of air ions. Another method is collisional induced dissociation that causes ions to fragment. Applying heating or cooling to ions in the gas phase are additional ways to modify ions.

### Prior Art for Ion Detection:

A few methods are used to detect ions in ion mobility spectrometers. These methods include measuring an ion current with an electrical current sensor, detecting them with an ion multiplier detector or detecting them with a condensation particle counter (CPC.

### Deficiencies of the Prior Art:

Prior art for ion mobility measurements has not defined a means to measure the changes in the ion mobility properties of a sample, such as average electrical mobility or the variation of ion mobility properties of a sample or of specific ions, concurrently with a period of time when the sample is exposed to physical or chemical stresses. An example is the lack of technology to measure the changes in the ion mobility properties of a sample while it is heated or while it is exposed to degrading chemicals. A second example of the lack of technology for measuring changes in the ion mobility properties of a sample, relates to the speed at which an ion mobility spectrum can be collected. Cylindrical and parallel plate ion mobility spectrometers have scan times of about 2 minutes. This slow scan time limits the amount of information that can be collected while a sample is being processed and typically necessitates that only one ion's mobility can be monitored. A choice has to be made as to which ion is monitored. To capture data for different ions, the analysis has to be repeated with different instrument settings. The capability to produce rapid ion mobility scans, particularly of singly-charge electrospray ions would advance the field of ion mobility spectrometry. Sample from a chromatography system may be conducted to modern ion mobility mass spectrometers, but this mode of operation does not provide a means to modify the sample physically or chemically before ion mobility measurements are performed.

### SUMMARY OF THE INVENTION

The present invention describes apparatuses and methods for measuring charged particle and ion electrical mobility. The term mobility will be understood to mean electrical mobility and the term ion will be understood to include material in the form of charged particles. The apparatuses described here provide control of ion generation, ion processing, ion separation via mobility, ion detection and gas flow for transporting ions through such devices. The components of the apparatuses can be understood to comprise an ion mobility spectrometer.

The apparatuses described here provide improved control of methodologies for determining ion mobility. The improved measurement scheme, illustrated in FIG. 1, provides an overview of the present invention and shows how combinations of new apparatus modules, when operated in conjunction with prior art, leads to improvements to ion mobility determinations. Apparatuses, comprised of modules selected from FIG. 1, are used to determine the average ion mobility for a substance and the variation of substance's ion mobility. We further describe apparatuses for determining the variation of a substance's ion mobility while a sample is processed or while a population of ions is processed. We additionally describe a way to determine a substance's average cross-sectional area and the variation of a substance's cross-sectional area.

Embodiments include a method of ion mobility spectrometry, comprising providing a sample material; modifying the sample material by exposing the sample material to physical stress to produce a modified material; generating ions from the modified material to produce generated ions; separating the generated ions to produce separated ions; and detecting the separated ions. The physical stress can be, e.g., heat, cold, light and/or a chemical reagent. The exposure can be constant, step-wise process during which the intensity of the exposure is increased in steps and/or by a steadily-changing process such as the application of ramped heating. Generally, the sample material is in the liquid phase and it is pumped through a capillary. In some embodiments, the sample material is located in a chamber, where an end of the capillary is located in the sample material; and a pressure and heat are provided to the chamber, where the sample material is heated to produce the modified material and where the pressure forces a portion of the modified material to flow through the capillary and out of the chamber. In other embodiments, the step of modifying the sample material includes pumping the sample through a capillary, where the sample material is pumped by a pumping mechanism selected from the group consisting of a syringe pump, a micro-fluidics pump and a liquid chromatography system. The modified material is delivered to an electrospray generator and are separated and detected. Embodiments of the invention modify the ions after they are generated. After detection, the data is processed mathematically to produce processed data; the invention further comprising converting the processed data into a form that is recognized by experts in the field of ion mobility spectrometry. The invention includes the apparatuses needed to carry out the methods.

### BRIEF DESCRIPTION OF THE DRAWINGS

The accompanying drawings, which are incorporated into and form a part of the disclosure, illustrate embodiments of the invention and, together with the description, serve to explain the principles of the invention.

FIG. 1 shows modules that can be combined to measure ion mobility.

FIG. 2 is an illustration of a liquid sample heated in a pressurized chamber.

FIG. 3A shows a design for heating sample as it is conducted towards an electrospray generator.

FIG. 3B shows a design where the sample is either heated or cooled as it passes between two thermos-electric coolers or heaters.

FIG. 4 shows a schematic of module for processing electrospray ions in the gas-phase.

FIG. 5 is a plot of ion count rate vs. the cross-sectional area for an antibody (solid black) and an antibody drug conjugate (black dashed) obtained with a nDMA setup consisting of modules 1-3, 5, 6 and 9 from FIG. 1.

FIG. 6 shows ion count rate vs. the cross-sectional area for three different antibodies: NISTmab (solid black), Waters mAb (black dashed) and Rituximab (black dotted) obtained with a nDMA setup consisting of modules 1-3, 5, 6 and 9 from FIG. 1.

FIG. 7 shows ion count rate vs. the cross-sectional area for a capsular polysaccharide obtained with a nDMA setup consisting of modules 1-3, 5, 6 and 9 from FIG. 1.

FIG. 8 shows ion count rate vs. the cross-sectional area for the protein biotherapeutic trastuzumab after the sample was isothermally processed at 60, 65, 69, 72, 78, or 80 deg C. for 1 hr obtained with a nDMA setup consisting of modules 1-3, 5, 6 and 9 from FIG. 1.

FIG. 9 shows ion count rate vs. temperature for the protein biotherapeutic trastuzumab as it was subjected to a 20 min temperature ramp from 25 to 100 deg C. obtained with a nDMA setup consisting of modules 1-3, 5, 6 and 9 from FIG. 1.

FIG. 10 shows ion count rate vs. temperature for an IgG2 antibody and an IgG2 antibody drug conjugate as they were subjected independently to 20 min temperature ramps from 25 to 100 deg C. obtained with a nDMA setup consisting of modules 1-3, 5, 6 and 9 from FIG. 1.

FIG. 11 shows ion count rate vs. temperature for a polysaccharide as it was subjected to a 20 min temperature ramp from 25 to 100 deg C. obtained with a nDMA setup consisting of modules 1-3, 5, 6 and 9 from FIG. 1. Data for this substance is also shown in FIG. 7.

### DETAILED DESCRIPTION OF THE INVENTION

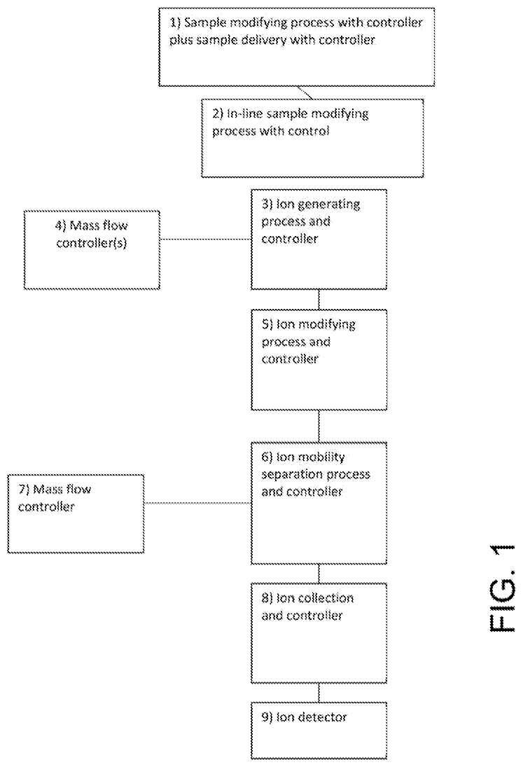

The analytical scheme and concept for an ion mobility apparatus and method of operation is presented in FIG. 1 which shows modules that can be combined to measure ion mobility. Beginning with Module 1, a flow of liquid sample in the range of 10-1000 nL/min is pumped through a capillary tube by means of pressure. Gas pressure can be applied to a chamber containing a reservoir of a liquid sample. The sample escapes from the chamber through a capillary tube inserted into the liquid. The liquid sample can alternatively be pumped through the capillary by means of a syringe that is loaded with the liquid sample and has a piston that expresses liquid from the syringe. The piston can be connected to a syringe pump. In one embodiment, the syringe is heated or cooled. The flow of sample from the reservoir or the syringe can be controlled by feedback from a flow sensor. Thus, in Module 1, a liquid sample is held in a chamber or a syringe where it can be processed, e.g., heated. This module delivers sample at a flow rate that can be automated with robotic sample handling mechanisms and is amenable to electrospray at 10-1000 nL/min range.

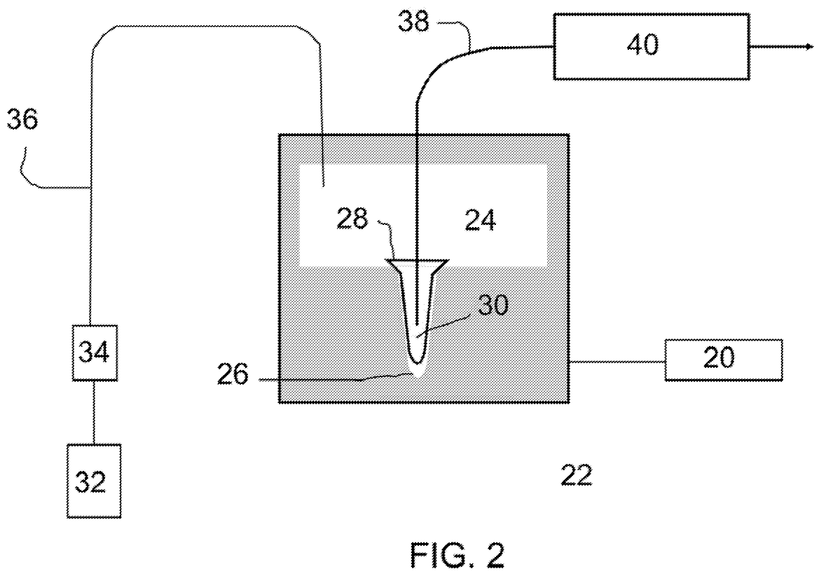

During the time the liquid sample resides in the pressurized chamber or in the syringe, the liquid sample can be exposed to physical stress, such as heat, cold or light. FIG. 2 shows the application of heat to the wall of a pressurized chamber which in turn conducts heat to the sample. The manner in which the liquid sample is exposed to a physical stress could be constant, a step-wise process during which the intensity of the exposure is increased in steps or by a steadily-changing process such as the application of ramped heating. During the time the sample resides in the reservoir, a chemical reagent could be added to the liquid sample as a way to introduce a chemical stress to the sample. Thus, FIG. 2 is an illustration of a liquid sample heated in a pressurized chamber. A heater 20 is configured to provide heat to chamber block or vessel 22 which includes an open chamber area 24. A means 26 for holding a sample, is included in the vessel 22 in such a way that a sample located within the means 26 will be exposed to the open chamber area 24. The particular means 26 illustrated in the figure is that of a notch within the inner wall of the vessel. In this embodiment, a microcentrifuge tube 28 with a sample 30 has been inserted into the notch. A means for pressurizing the open area 24 is provided. In this embodiment, a pressurized gas within a container 32 is directed through a pressure controller 34, through a tube 36 and into the open area 24 of chamber vessel 22. A capillary tube 38 fed through the vessel wall and into the open area has an end located in the sample 30. Under the appropriate conditions, portions of the sample can flow from the microcentrifuge tube 28 into the tube 38 and out of the chamber to flow through a flow sensor 40.

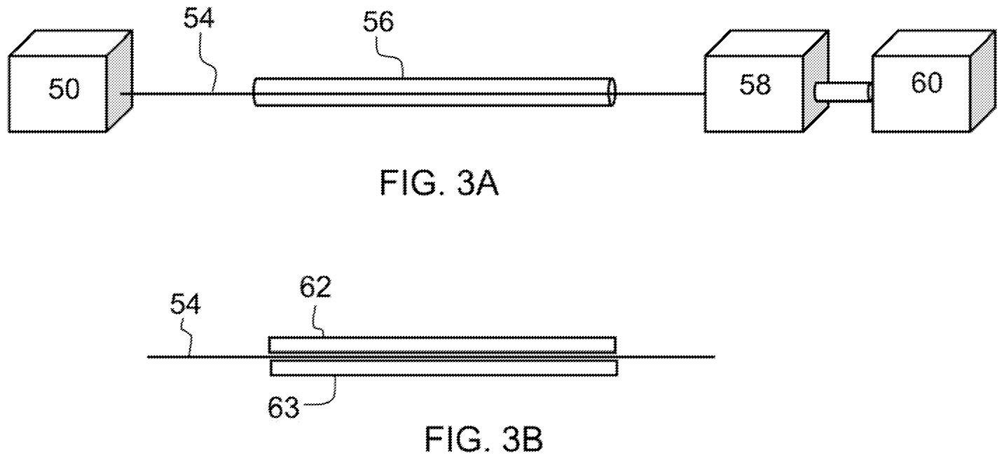

An alternative to the technique of Module 1 for processing a sample, is designated as Module 2 in FIG. 1 and is shown in FIGS. 3A and 3B where a physical or chemical stress is applied to the liquid sample as it is pumped from the pressurized chamber or syringe. This can be realized by positioning a heater or chiller around the capillary tube that conducts liquid from the pressurized chamber or the syringe. In this approach, the heater or chiller could be operated isothermally, set to values of constant physical or chemical stress, such as a 0.30 to 40 degree setting, and further temperature steps approaching a boiling point setting established by the properties of the liquid. The sample could be subjected to a chemical stress by introducing a small flow of a liquid chemical through a TEE in the capillary that conducts the sample from the reservoir to the next module. The TEE provides a way to mix the chemical stressor with the liquid sample. An aspect for sample processing is the design of a heater or chiller that surrounds the capillary the conducts liquid sample from the reservoir or syringe to the next module. Two examples for the design of a capillary heater/chiller are presented, one in FIG. 3A and another in FIG. 3B. Another example of sample processing/heating is the use of tunable laser radiation to impart thermal, oxidative or bond-breaking stress to the sample. Thus, embodiments provide designs for heating or cooling the sample as it is conducted towards an electrospray generator. FIG. 3A shows a design for heating sample as it is conducted towards an electrospray generator. The sample is heated as it passes through a tube heater. More specifically, the figure shows a syringe and syringe pump 50 having a sample 52 which can be pushed into capillary 54, followed by a flow sensor 56. One alternative to the syringe and syringe pump 50 is a micro-fluidics pump 50. Capillary heater (or cooler) 58 surrounds the capillary through which the sample propagates to an electrospray generator 60. FIG. 3B shows a design where the sample is either heated or cooled in the capillary 54 which is located between two thermo-electric coolers or heaters 62, 63. The separation between the blades of thermo-electric coolers or heaters 62 is exaggerated. All other elements can be identical to that of the exemplary embodiment of FIG. 3A. The sample is either heated or cooled as it passes between two thermos-electric coolers or heaters. It can be understood that a syringe and syringe pump could be substituted with a liquid chromatography system and the output from the chromatography system conducted to a sample processing module. Thus, Module 2, examples of which are shown in FIGS. 3A and 3B, provides that while the sample is conducted to the ion generating process, it can be treated by, e.g., exposure to physical processing, chemical reactants or a clean-up process, such as heating, addition of acid, exposure to tunable laser radiation and in-line desalting.

Module 3 in FIG. 1, provides a means for electrospraying the liquid sample. One example of this module is a commercially available electrospray source (Model 3480, TSI. Inc.). Controlling the flows of gases that are introduced into the Model 3480 is provided by low-resolution rotameters. One aspect of the current invention is to provide stable delivery of gases to an electrospray generator by using mass flow controllers that are accurate to +/−2% of the full-scale flowrate so that accurate quantitation of the electrosprayed ion concentration can be obtained. A first mass flow controller introduces a stable flow of air into an electrospray ion generating chamber so that the resulting ion-laden gas can be introduced into a mobility analyzer. A second mass flow controller introduces an auxiliary flow of gas, such as CO₂ or another corona-suppressing gas, into the same ion generating chamber for the purpose of influencing the ion generating process. The application of mass-flow controllers is represented in FIG. 1 with Module 4. An additional feature of the present apparatus is to locate a camera on the ion generating chamber for the purpose of visually observing the ion generating process. Furthermore, a feature of the present invention is to use image recognition software, along with a sensor to monitor the electrospray current, as a means to provide feedback to the electrospray process for the purpose of improving the stability of the electrospray process. Thus, in Module 3, ions are generated by the electrospray process, including those disclosed in U.S. Pat. No. 9,666,423, incorporated herein by reference. Control of the electrospray process can be provided by feedback from an electrospray sensor such as a current measuring device or a camera. Predictive machine intelligence software such as image recognition provide new target parameters for electrospray process control. A flow(s) of gas is provided by a mass flow controller(s) (Module 4) for transporting electrospray ions, optionally to Module 5 and then to Module 6, or directly to Module 6.

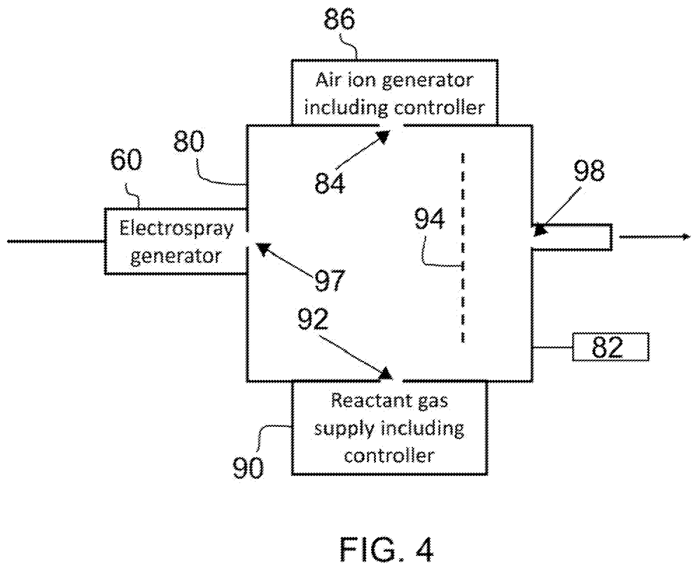

Module 5 in FIG. 1, presents another aspect of the present invention. A means is provided for processing electrospray ions. Module 5 represents an axillary chamber that can be heated, cooled or supplied with a reactant gas that transforms electrospray ions. FIG. 4 illustrates a design of Module 5 for an electrospray ion processing chamber where ions can be processed to alter the charge they carry, processed physically, such as by heating, or with reactant gas(s). One way to process electrospray ions is to heat or cool them. The thermostatically controlled chamber in FIG. 4 can be heated or cooled by use of an oven or chiller. Thermo-electric devices offer an optional way to select heating or cooling of the chamber simply by reversing the voltage polarity provided to the thermo-electric device. UV light generators or alpha-emitting radioactive sources, such as a Polonium source, have been described to alter the charge on electrospray ions. One aspect of the current invention is to provide control of the charge-altering methodology. In applications involving Polonium as an ion charge reducing agent, positioning an aperture between the Polonium source and the source of electrospray ions provides a way to control the charge reducing process. One example of the use of an aperture is to use a variable area aperture such as an iris that is used in optical systems. Another example of ion processing/heating is the use of tunable laser radiation to impart thermal, oxidative or bond-breaking stress to the ions in the gas phase. Thus, FIG. 4 shows an exemplary Module 5 for processing electrospray ions in the gas-phase. The module consists of a chamber 80, the temperature of which is controlled by a thermostatic controller 82. Air ions are injected through a port 84 of chamber 80. The air ions are produced by an air ion generator/controller 86. Reactant gas from supply 90 can be provided through port 92 of chamber 80. The chamber includes a mixing baffle 94. In one embodiment, ions from electrospray ion generator 60 of FIG. 3A are injected into port 97, which then flow through the module and out an exit port 98.

Module 6 in FIG. 1 illustrates the use of an ion mobility spectrometer. Two common types of ion mobility spectrometers that are used to measure an ion's electrical mobility, or the electrical mobility of a cloud of ions, are cylindrical or parallel plate ion mobility spectrometers, such as are commercially available from TSI, Inc or SEADM, as discussed above. See also such devices disclosed in U.S. Pat. No. 9,666,423, incorporated herein by reference. One aspect of the present invention is to use a mass flow controller to provide a stable flow of gas in either of these devices instead of the way they are designed to operate.

For example, a mass flow controller provides a stable flow of gas, the so-called sheath flow into the annular space between the inner and outer cylinders in the TSI nDMA in a manner where this flow combines with the flow from the ion generating chamber. So that flowrate of sheath gas introduced into the annular space between the cylindrical electrodes equals the flowrate of gas exiting from the sheath gas exit, a flow restriction device is positioned in the flow of gas that carries mobility selected ions away from the nDMA.

An additional aspect of the present invention is to substitute an ion mobility ToF spectrometer or an ion mobility mass spectrometer for Module 6 in FIG. 1 for the purposes of improving the quality of ion mobility measurements. An ion mobility spectrometer or an ion mobility mass spectrometer that operates on the principle of time-of-flight for determining ion mobility may have high data acquisition capability that provides a way to produce ion mobility spectra across a large range of ion cross-sectional areas in a few seconds compared to the concentric cylinder or parallel plate ion mobility spectrometers. This rapid scan feature provides a way to examine a plethora of ions simultaneously compared to a ‘single ion’ ion mobility measurement discussed in the summary of prior art. Thus, in Module 6, ions are subjected to ion mobility separation such as a nDMA, parallel plate DMA or ToF spectrometry. Gas flow is provided by mass flow controllers (Module 7).

Module 8 in FIG. 1 represents a way to capture ions after they have been subjected to ion mobility analysis or separation. In this module, ions can be collected for subsequent analysis. After ions have passed through a concentric cylinder nDMA or a parallel plate DMA, they can be collected electrostatically onto a conducting surface that is maintained with a voltage sufficient to electrostatically attract ions. For example, positive ions can be collected onto a metal surface maintained at a high negative voltage. An alternative means for collecting ions after ion mobility separation is a device such as a nano-particle sampler (Model 3089, TSI, Inc.) or a device that captures condensation droplets generated by a device such as a CPC. Alternately, ions may be captured by techniques disclosed in U.S. Pat. No. 9,666,423, and in U.S. patent application Ser. No. 15/607,657, both incorporated herein by reference.

Module 9 illustrates the final module in ion mobility spectrometry-ion detection. Ions may be detected by means of an electrical current sensor, CPC or mass spectrometer. When concentric-cylinder NDMA or parallel plat DMA are utilized, ion detection is performed typically by use of a CPC. Ion mobility mass spectrometers utilize ion multiplier detection and a ToF ion mobility spectrometer such as in U.S. Pat. No. 9,666,423, and in U.S. patent application Ser. No. 15/607,657, both incorporated herein by reference, utilize an electric current sensing detector.

Nine modules, illustrated in FIG. 1, comprise one version of the present invention. It should be understood that not all nine modules are required for operation of the apparatus and that modules can be eliminated or arranged in different orders of configuration.

A feature of the present invention referred to as Module 10 is to process nDMA data, DMA data or ToF ion mobility data mathematically and convert the raw data into a form that is recognized by experts in the field of ion mobility spectrometry. In the field of aerosol science, raw ion mobility data is typically converted to particle diameter. This leads to particle size distributions expressed as particle number concentration vs. particle diameter. In the life science field, raw ion mobility data is typically converted to cross-sectional area (CSA) or collisional cross-section (CCS) and leads in size distributions that are plots of ion count rate vs. CSA or CCS. In Module 10, software can be utilized to provide Data acquisition and data analysis for processing of multi-dimensional data into reports. Example reports include ion counts vs. temperature or collision cross-sectional area and the evaluation of the stability of a sample substance

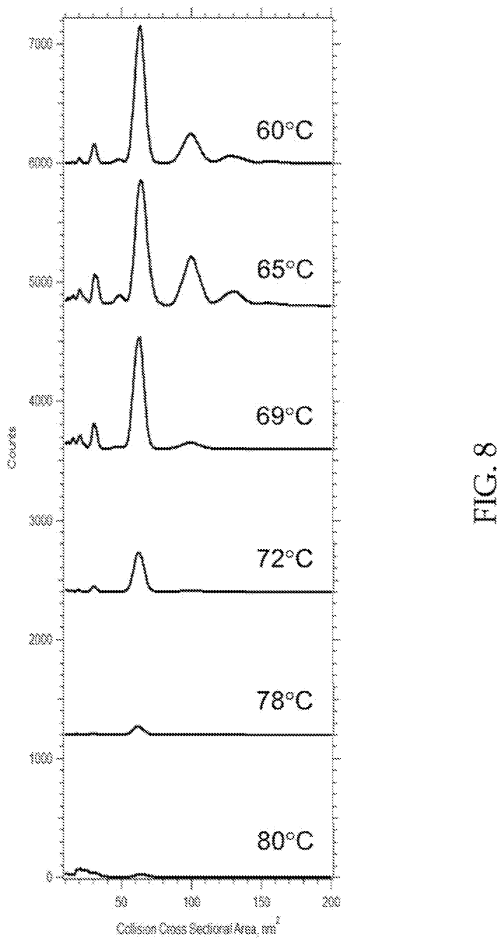

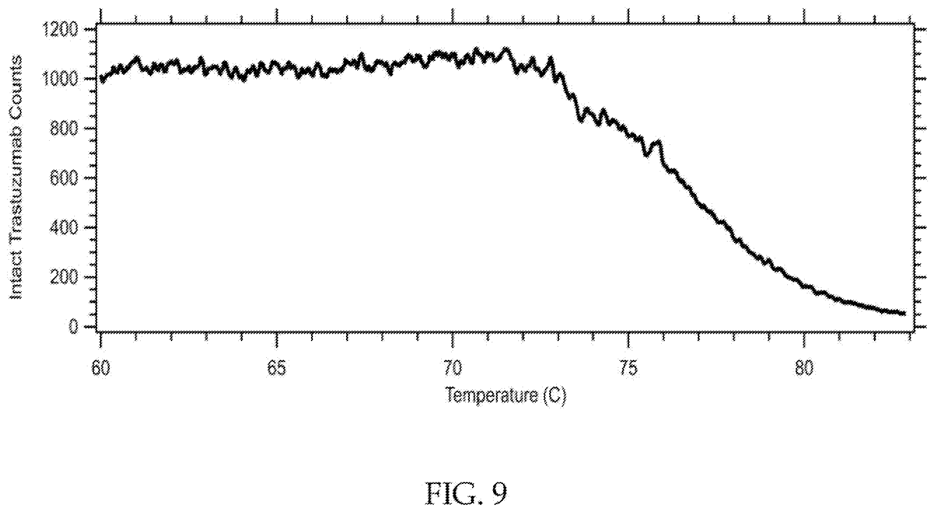

Another feature of the present invention is to process ion mobility data as a function of sample temperature, either by monitoring ion counts at a single range of ion mobility or by collecting rapid scans of ion mobility across a wide range. This embodiment of the invention produces an ion mobility-derived thermal stability plot, herein referred to as an ion mobility thermogram (see FIG. 9). Combination of the current invention with data manipulation and analysis software allows for plotting of multi-dimensional ion mobility data, e.g., Ion Counts vs. Sample Temperature vs. Collision Cross-Sectional Area. For example, the full range of ion mobility measured for the isothermal heating in FIG. 8 can be captured for every data point in FIG. 9 if a rapid scanning ToF ion mobility spectrometer is employed. Each dimension of the multidimensional data set can relate to a different sample processing parameter.

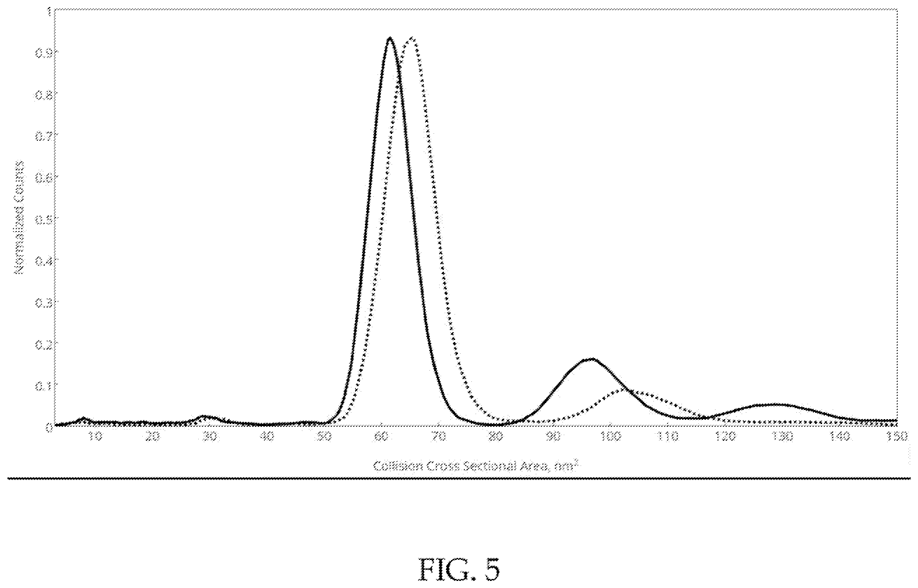

Thermograms are one type of data output but the apparatuses are not limited to thermal stability studies and includes detecting other forms of physical changes that alter an ion's mobility. The type of data that can be generated with the apparatuses presently described is illustrated in FIGS. 5-11 for the purpose of providing examples of analytical methods and applications. The applications presented for the apparatuses is not limited to these setups nor are the methods limited to the substances that were analyzed.

FIG. 5 is a plot of ion count rate vs. the cross-sectional area for an antibody (solid black) and an antibody drug conjugate (black dashed) obtained with a nDMA setup consisting of modules 1-3, 5, 6 and 9 from FIG. 1.

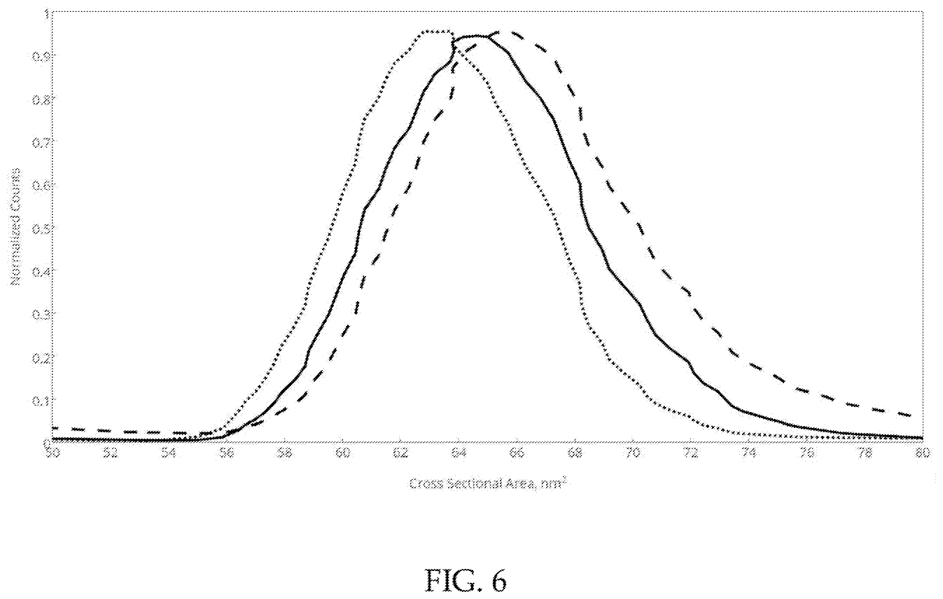

FIG. 6 shows ion count rate vs. the cross-sectional area for three different antibodies: NISTmab (solid black), Waters mAb (black dashed) and Rituximab (black dotted) obtained with a nDMA setup consisting of modules 1-3, 5, 6 and 9 from FIG. 1.

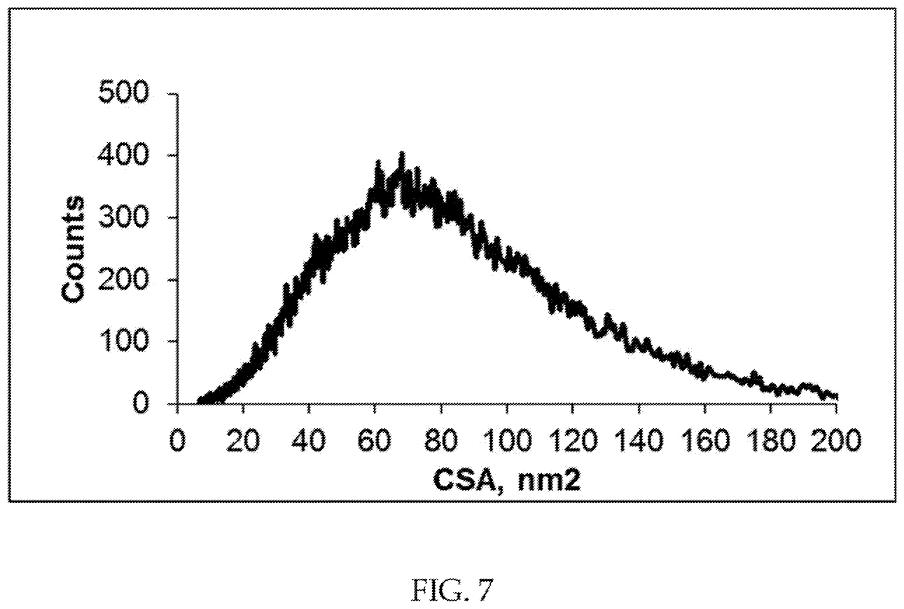

FIG. 7 shows ion count rate vs. the cross-sectional area for a capsular polysaccharide obtained with a nDMA setup consisting of modules 1-3, 5, 6 and 9 from FIG. 1.

FIG. 8 shows ion count rate vs. the cross-sectional area for the protein biotherapeutic trastuzumab after the sample was isothermally processed at 60, 65, 69, 72, 78, or 80 deg C. for 1 hr obtained with a nDMA setup consisting of modules 1-3, 5, 6 and 9 from FIG. 1.

FIG. 9 shows ion count rate vs. temperature for the protein biotherapeutic trastuzumab as it was subjected to a 20 min temperature ramp from 25 to 100 deg C. obtained with a nDMA setup consisting of modules 1-3, 5, 6 and 9 from FIG. 1.

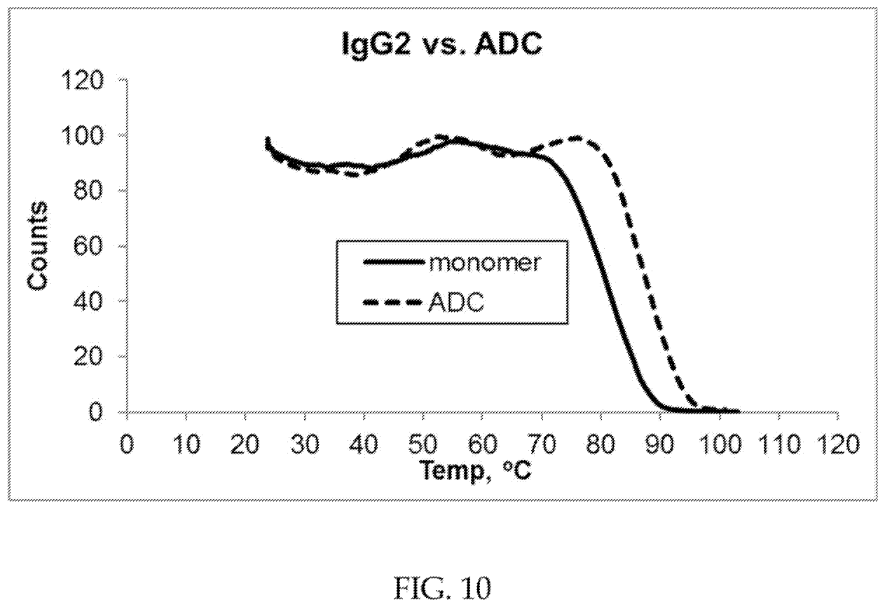

FIG. 10 shows ion count rate vs. temperature for an IgG2 antibody and an IgG2 antibody drug conjugate as they were subjected independently to 20 min temperature ramps from 25 to 100 deg C. obtained with a nDMA setup consisting of modules 1-3, 5, 6 and 9 from FIG. 1.

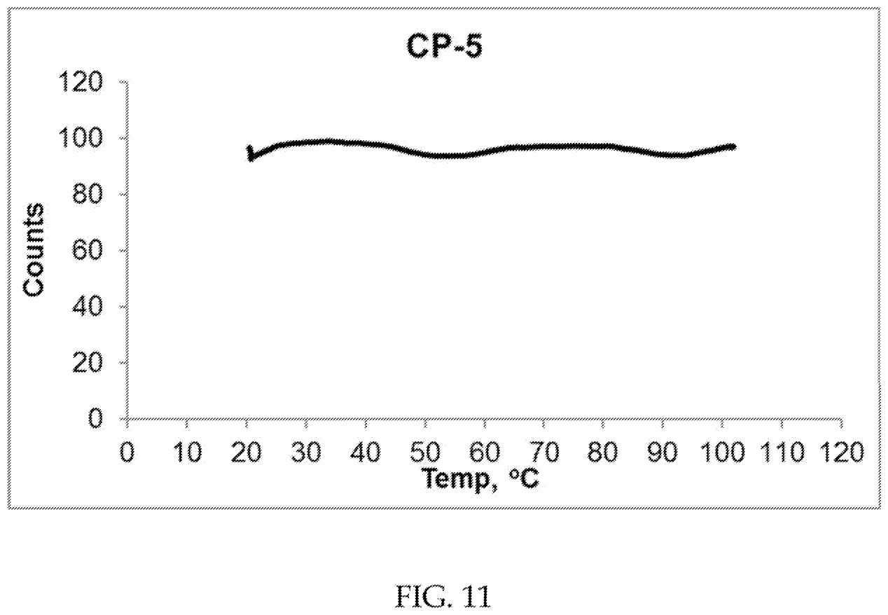

FIG. 11 shows ion count rate vs. temperature for a polysaccharide as it was subjected to a 20 min temperature ramp from 25 to 100 deg C. obtained with a nDMA setup consisting of modules 1-3, 5, 6 and 9 from FIG. 1. Data for this substance is also shown in FIG. 7.

Concepts:

This writing also presents at least the following concepts:

1. A method, comprising:

providing a sample material;

modifying said sample material by exposing said sample material to physical stress to produce a modified material;

generating ions from said modified material to produce generated ions;

separating said generated ions to produce separated ions; and

detecting said separated ions.

2. The method of concepts 1, 2-5, 7, 11, 16-18, 22-27, 29-31, 33 and 35, wherein the step of exposing said sample material to physical stress comprises exposing said sample material to at least one of heat, cold, light or a chemical reagent.

3. The method of concepts 1, 2, 4, 5, 7, 11, 16-18, 22-27, 29-31, 33 and 35, wherein said sample material is constantly exposed to said physical stress.

4. The method of concepts 1-3, 5, 7, 11, 16-18, 22-27, 29-31, 33 and 35, wherein said sample material is exposed to said physical stress in a step-wise process during which the intensity of the exposure is increased in steps.

5. The method of concepts 1-4, 7, 11, 16-18, 22-27, 29-31, 33 and 35, wherein said sample material is constantly exposed to said physical stress by a steadily-changing process.

6. The method of concepts 5, wherein said steadily-changing process comprises the application of ramped heating.

7. The method of concepts 1-6, 11, 16-18, 22-27, 29-31, 33 and 35, wherein said sample material is in the liquid phase, wherein the step of modifying said sample material includes pumping said sample through a capillary.

8. The method of concepts 7, wherein the step of pumping said sample material through a capillary comprises:

providing a chamber;

locating said sample material in said chamber, wherein an end of said capillary is located in said sample material; and

providing pressure and heat to said chamber, wherein said sample material is heated to produce said modified material and wherein said pressure forces a portion of said modified material to flow through said capillary and out of said chamber.

9. The method of concepts 8, further comprising monitoring the rate of said flow.

10. The method of concepts 8, further comprising controlling said flow with a feedback mechanism.

11. The method of concepts 1-10, 11, 16-18, 22-27, 29-31, 33 and 35, wherein said sample is in the liquid phase, wherein the step of modifying said sample material includes pumping said sample through a capillary, wherein said sample material is pumped by a pumping mechanism selected from the group consisting of a syringe pump, a micro-fluidics pump and a liquid chromatography system.

12. The method of concepts 11, wherein the step of modifying said sample material includes heating said capillary, wherein said heat transfers to said sample material.

13. The method of concepts 11, wherein the step of modifying said sample material includes cooling said capillary, wherein said sample material is cooled.

14. The method of concepts 11, wherein the step of modifying said sample material includes utilizing thermo-electric coolers or heaters to cool or heat said capillary.

15. The method of concepts 11, wherein the step of modifying said sample material includes introducing a flow of a liquid chemical into said capillary.

16. The method of concepts 1-15, 11, 17, 18, 22-27, 29-31, 33 and 35, wherein the step of modifying said sample material includes the use of tunable laser radiation to impart thermal, oxidative or bond-breaking stress to said sample material.

17. The method of concepts 1-16, 18, 22-27, 29-31, 33 and 35, wherein the step of modifying said sample material includes desalting said sample material.

18. The method of concepts 1-17, 22-27, 29-31, 33 and 35, wherein said modified material is conducted to an electrospray generator to produce said generated ions.

19. The method of concepts 18, wherein stable delivery of gases is provided to said electrospray generator by using mass flow controllers that are accurate to +/−2% of the full-scale flowrate so that accurate quantitation of the electro-sprayed ion concentration can be obtained.

20. The method of concepts 19, further comprising operatively locating a camera for producing images of the ion generating process.

21. The method of concepts 20, further comprising processing said images with image recognition software, along with a sensor to monitor the electrospray current, as a means to provide feedback to the electrospray process for the purpose of improving the stability of the electrospray process.

22. The method of concepts 1-21, 23-27, 29-31, 33 and 35, further comprising modifying said generated ions prior to the step of separating said ions.

23. The method of concepts 1-22, 24-27, 29-31, 33 and 35, further comprising modifying said generated ions in an auxiliary chamber prior to the step of separating said ions, wherein said auxiliary chamber is heated.

24. The method of concepts 1-23, 25-27, 29-31, 33 and 35, further comprising modifying said generated ions in an auxiliary chamber prior to the step of separating said ions, wherein said auxiliary chamber is cooled.

25. The method of concepts 1-24, 26, 27, 29-31, 33 and 35, further comprising modifying said generated ions in an auxiliary chamber prior to the step of separating said ions, wherein said auxiliary chamber is supplied with a reactant gas.

26. The method of concepts 1-25, 27, 29-31, 33 and 35, further comprising modifying said generated ions in an auxiliary chamber prior to the step of separating said ions, wherein the temperature of said auxiliary chamber is controlled, wherein air ions are injected through a port, wherein reactant gas is provided through another port, wherein said chamber includes a mixing baffle.

27. The method of concepts 1-26, 29-31, 33 and 35, wherein the step of separating said ions to produce separated ions is carried out with an ion mobility spectrometer.

28. The method of concepts 27, further comprising utilizing a mass flow controller to provide a stable flow of gas to said ion mobility spectrometer.

29. The method of concepts 1-28, 30, 31, 33 and 35, wherein the step of separating said generated ions to produce separated ions is carried out with an ion mobility ToF spectrometer.

30. The method of concepts 1-29, 31, 33 and 35, wherein the step of separating said generated ions to produce separated ions is carried out with an ion mobility mass spectrometer.

31. The method of concepts 1-30, 33 and 35, wherein the step of detecting said generated ions includes capturing said separated ions.

32. The method of concepts 31, wherein the step of capturing said separated ions includes electrostatically collecting said separated ions onto a conducting surface that is maintained with a voltage sufficient to electrostatically attract said separated ions.

33. The method of concepts 1-32 and 35 wherein the step of detecting said separated ions is carried out with an ion detector.

34. The method of concepts 33, wherein said ion detector is selected from the group consisting of a condensation particle counter, an electrical current sensor and a mass spectrometer.

35. The method of concepts 1-34, wherein the step of detecting said separated ions produces data, the method further comprising processing said data mathematically to produce processed data; and converting said processed data into a form that is recognized by experts in the field of ion mobility spectrometry.

36. An apparatus, comprising:

means for modifying a sample material by exposing said sample material to physical stress to produce a modified material;

means for generating ions from said modified material to produce generated ions;

means for separating said generated ions to produce separated ions; and

means for detecting said separated ions.

37. The apparatus of concepts 36, 38-40, 42, 46, 51-53, 57-62, 64-66, 68 and 70, wherein said means for modifying a sample comprises means for exposing said sample material to at least one of heat, cold, light or a chemical reagent.

38. The apparatus of concepts 36, 37, 39, 40, 42, 46, 51-53, 57-62, 64-66, 68 and 70, wherein said means for modifying a sample material constantly exposes said sample material to said physical stress.

39. The apparatus of concepts 36-38, 40, 42, 46, 51-53, 57-62, 64-66, 68 and 70, wherein said means for modifying a sample material exposes said sample material to said physical stress in a step-wise process during which the intensity of the exposure is increased in steps.

40. The apparatus of concepts 36-39, 42, 46, 51-53, 57-62, 64-66, 68 and 70, wherein said means for modifying a sample material constantly exposes said sample material to said physical stress by a steadily-changing process.

41. The apparatus of concepts 40, wherein said steadily-changing process comprises the application of ramped heating.

42. The apparatus of concepts 36-41, 46, 51-53, 57-62, 64-66, 68 and 70, wherein said sample material is in the liquid phase, wherein said means for modifying said sample material includes means for pumping said sample material through a capillary.

43. The apparatus of concepts 42, wherein said means for pumping said sample material through a capillary comprises:

a chamber;

means for locating said sample material in said chamber, wherein an end of said capillary is located in said sample material; and

means for providing pressure and heat to said chamber, wherein said sample material is heated to produce said modified material and wherein said pressure forces a portion of said modified material to flow through said capillary and out of said chamber.

44. The apparatus of concepts 43, further comprising means for monitoring the rate of said flow.

45. The apparatus of concepts 43, further comprising means for controlling said flow with a feedback mechanism.

46. The apparatus of concepts 36-45, 51-53, 57-62, 64-66, 68 and 70, wherein said sample is in the liquid phase, wherein said means for modifying said sample material includes means for pumping said sample through a capillary, wherein said sample material is pumped by a pumping mechanism selected from the group consisting of a syringe pump, a micro-fluidics pump and a liquid chromatography system.

47. The apparatus of concepts 46, wherein said means for modifying said sample material includes means for heating said capillary, wherein said heat transfers to said sample material.

48. The apparatus of concepts 46, wherein said means for modifying said sample material includes means for cooling said capillary, wherein said sample material is cooled.

49. The apparatus of concepts 46, wherein said means for modifying said sample material includes thermo-electric coolers or heaters to cool or heat said capillary.

50. The apparatus of concepts 46, wherein said means for modifying said sample material includes means for introducing a flow of a liquid chemical into said capillary.

51. The apparatus of concepts 36-50, 52, 53, 57-62, 64-66, 68 and 70, wherein said means for modifying said sample material includes means for providing tunable laser radiation to impart thermal, oxidative or bond-breaking stress to said sample material.

52. The apparatus of concepts 36-51, 53, 57-62, 64-66, 68 and 70, wherein said means for modifying said sample material includes means for desalting said sample material.

53. The apparatus of concepts 36-52, 57-62, 64-66, 68 and 70, wherein said means for generating ions comprises an electrospray generator configured to produce said generated ions.

54. The apparatus of concepts 53, further comprising a mass flow controller that is accurate to +/−2% of the full-scale flowrate so that accurate quantitation of the electro-sprayed ion concentration can be obtained, wherein stable delivery of gases is provided to said electrospray generator by using said mass flow controller.

55. The apparatus of concepts 54, further comprising a camera operatively located for producing images of the ion generating process.

56. The apparatus of concepts 55, further comprising means for processing said images with image recognition software, along with a sensor to monitor the electrospray current, as a means to provide feedback to the electrospray process for the purpose of improving the stability of the electrospray process.

57. The apparatus of concepts 36-56, 58-62, 64-66, 68 and 70, further comprising means for modifying said generated ions prior to separating said ions.

58. The apparatus of concepts 36-57, 59-62, 64-66, 68 and 70, further comprising means for modifying said generated ions in an auxiliary chamber prior to separating said ions, wherein said auxiliary chamber is heated.

59. The apparatus of concepts 36-58, 60-62, 64-66, 68 and 70, further comprising means for modifying said generated ions in an auxiliary chamber prior to separating said ions, wherein said auxiliary chamber is cooled.

60. The apparatus of concepts 36-59, 61, 62, 64-66, 68 and 70, further comprising means for modifying said generated ions in an auxiliary chamber prior to separating said ions, wherein said auxiliary chamber is supplied with a reactant gas.

61. The apparatus of concepts 36-60, 64-66, 68 and 70, further comprising means for modifying said generated ions in an auxiliary chamber prior to separating said ions, wherein the temperature of said auxiliary chamber is controlled, wherein air ions are injected through a port, wherein reactant gas is provided through another port, wherein said chamber includes a mixing baffle.

62. The apparatus of concepts 36-61, 64-66, 68 and 70, wherein said means for separating said ions to produce separated ions is carried out with an ion mobility spectrometer.

63. The apparatus of concepts 62, further comprising a mass flow controller to provide a stable flow of gas to said ion mobility spectrometer.

64. The apparatus of concepts 36-63, 65, 66, 68 and 70, wherein said means for separating said generated ions to produce separated ions is carried out with an ion mobility ToF spectrometer.

65. The apparatus of concepts 36-64, 66, 68 and 70, wherein said means for separating said generated ions to produce separated ions is carried out with an ion mobility mass spectrometer.

66. The apparatus of concepts 36-65, 68 and 70, wherein said means for detecting said generated ions includes means for capturing said separated ions.

67. The apparatus of concepts 66, wherein said means for capturing said separated ions includes means for electrostatically collecting said separated ions onto a conducting surface that is maintained with a voltage sufficient to electrostatically attract said separated ions.

68. The apparatus of concepts 36-67 and 70 wherein said means for detecting said separated ions is carried out with an ion detector.

69. The apparatus of concepts 68, wherein said ion detector is selected from the group consisting of a condensation particle counter, an electrical current sensor and a mass spectrometer.

70. The apparatus of concepts 36-69, wherein said means for detecting said separated ions produces data, the apparatus further comprising means for processing said data mathematically to produce processed data; said apparatus further comprising means for converting said processed data into a form that is recognized by experts in the field of ion mobility spectrometry.

The foregoing description of the invention has been presented for purposes of illustration and description and is not intended to be exhaustive or to limit the invention to the precise form disclosed. Many modifications and variations are possible in light of the above teaching. The embodiments disclosed were meant only to explain the principles of the invention and its practical application to thereby enable others skilled in the art to best use the invention in various embodiments and with various modifications suited to the particular use contemplated. The scope of the invention is to be defined by the following claims.

1. A method, comprising:
providing a sample material;
modifying said sample material by exposing said sample material to physical stress to produce a modified material;
generating ions from said modified material to produce generated ions;
separating said generated ions to produce separated ions; and
detecting said separated ions.

2. The method of claim 1, wherein the step of exposing said sample material to physical stress comprises exposing said sample material to at least one of heat, cold, light or a chemical reagent.

3-4. (canceled)

5. The method of claim 1, wherein said sample material is constantly exposed to said physical stress by a steadily-changing process.

6. (canceled)

7. The method of claim 1, wherein said sample material is in the liquid phase, wherein the step of modifying said sample material includes pumping said sample through a capillary, wherein the step of pumping said sample material through a capillary comprises:
providing a chamber;
locating said sample material in said chamber, wherein an end of said capillary is located in said sample material; and
providing pressure and heat to said chamber, wherein said sample material is heated to produce said modified material and wherein said pressure forces a portion of said modified material to flow through said capillary and out of said chamber.

8-10. (canceled)

11. The method of claim 1, wherein said sample is in the liquid phase, wherein the step of modifying said sample material includes pumping said sample through a capillary, wherein said sample material is pumped by a pumping mechanism selected from the group consisting of a syringe pump, a micro-fluidics pump and a liquid chromatography system, wherein the step of modifying said sample material includes introducing a flow of a liquid chemical into said capillary.

12-15. (canceled)

16. The method of claim 1, wherein the step of modifying said sample material includes the use of tunable laser radiation to impart thermal, oxidative or bond-breaking stress to said sample material.

17. (canceled)

18. The method of claim 1, wherein said modified material is conducted to an electrospray generator to produce said generated ions, wherein stable delivery of gases is provided to said electrospray generator by using mass flow controllers that are accurate to +/−2% of the full-scale flowrate so that accurate quantitation of the electro-sprayed ion concentration can be obtained.

19. (canceled)

20. The method of claim 18, further comprising operatively locating a camera for producing images of the ion generating process, further comprising processing said images with image recognition software, along with a sensor to monitor the electrospray current, as a means to provide feedback to the electrospray process for the purpose of improving the stability of the electrospray process.

21-30. (canceled)

31. The method of claim 1, wherein the step of detecting said generated ions includes capturing said separated ions, wherein the step of capturing said separated ions includes electrostatically collecting said separated ions onto a conducting surface that is maintained with a voltage sufficient to electrostatically attract said separated ions.

32. (canceled)

33. The method of claim 1, wherein the step of detecting said separated ions is carried out with an ion detector, wherein said ion detector is selected from the group consisting of a condensation particle counter, an electrical current sensor and a mass spectrometer, wherein the step of detecting said separated ions produces data, the method further comprising processing said data mathematically to produce processed data; and converting said processed data into a form that is recognized by experts in the field of ion mobility spectrometry.

34-35. (canceled)

36. An apparatus, comprising:
means for modifying a sample material by exposing said sample material to physical stress to produce a modified material;
means for generating ions from said modified material to produce generated ions;
means for separating said generated ions to produce separated ions; and
means for detecting said separated ions.

37. The apparatus of claim 36, wherein said means for modifying a sample comprises means for exposing said sample material to at least one of heat, cold, light or a chemical reagent.

38-39. (canceled)

40. The apparatus of claim 36, wherein said means for modifying a sample material constantly exposes said sample material to said physical stress by a steadily-changing process.

41. (canceled)

42. The apparatus of claim 36, wherein said sample material is in the liquid phase, wherein said means for modifying said sample material includes means for pumping said sample material through a capillary, wherein said means for pumping said sample material through a capillary comprises:
a chamber;
means for locating said sample material in said chamber, wherein an end of said capillary is located in said sample material; and
means for providing pressure and heat to said chamber, wherein said sample material is heated to produce said modified material and wherein said pressure forces a portion of said modified material to flow through said capillary and out of said chamber.

43-52. (canceled)

53. The apparatus of claim 36, wherein said means for generating ions comprises an electrospray generator configured to produce said generated ions.

54. The apparatus of claim 53, further comprising a mass flow controller that is accurate to +/−2% of the full-scale flowrate so that accurate quantitation of the electro-sprayed ion concentration can be obtained, wherein stable delivery of gases is provided to said electrospray generator by using said mass flow controller.

55. The apparatus of claim 54, further comprising a camera operatively located for producing images of the ion generating process.

56. The apparatus of claim 55, further comprising means for processing said images with image recognition software, along with a sensor to monitor the electrospray current, as a means to provide feedback to the electrospray process for the purpose of improving the stability of the electrospray process.

57. The apparatus of claim 36, further comprising means for modifying said generated ions prior to separating said ions.

58-65. (canceled)

66. The apparatus of claim 36, wherein said means for detecting said generated ions includes means for capturing said separated ions.

67. The apparatus of claim 66, wherein said means for capturing said separated ions includes means for electrostatically collecting said separated ions onto a conducting surface that is maintained with a voltage sufficient to electrostatically attract said separated ions.

68. The apparatus of claim 36, wherein said ion detector is selected from the group consisting of a condensation particle counter, an electrical current sensor and a mass spectrometer, wherein said means for detecting said separated ions is carried out with an ion detector.

69-70. (canceled)
